(19) United States
(12) Patent Application Publication
(10) Pub. No.: US 2012/0191546 A1
(43) Pub. Date: Jul. 26, 2012

(54) Email Strategy Templates System and Method

(75) Inventors: Ryan Patrick Phelan, La Mesa, CA (US); Manfred Tsen-Shu Ju, Salem, OR (US)

(73) Assignee: DIGITAL RIVER, INC., Minnetonka, MN (US)

(21) Appl. No.: 13/358,440

(22) Filed: Jan. 25, 2012

Related U.S. Application Data
(60) Provisional application No. 61/436,140, filed on Jan. 25, 2011.

(51) Int. Cl. G06Q 30/02

(52) U.S. Cl. 705/14.67; 705/14.66

(57) ABSTRACT

An email message system with email strategy templates for use on a network is disclosed. A subscriber profile record includes an email address, a demographic, and status information for that subscriber's actions with prior emails or other events. Templates are provided with a predefined segment of the profile data that defines an initial audience for the marketing campaign, a first and second template with default title and content and a sending rule setting a delay between emails based on the first and the second templates. User input, profile data, and templates create a rule for sending messages to subscribers with particular status information for that subscriber's actions with prior emails. An email campaign manager sends a personalized message to at least one selected subscriber over the network based on the rule whereby, the selected subscriber receives the message as a result of having particular status for actions with prior emails.

### RELATED APPLICATIONS

This application claims the benefit of U.S. Provisional Application No. 61/436,140 filed 25 Jan. 2011, entitled “Email Strategy Templates System and Method”, and which is incorporated herein by reference.

### FIELD OF THE INVENTION

The present invention relates to electronic messaging systems for use on the internet. More particularly, the present invention relates to a system and related tools for quickly creating email marketing campaigns from predefined templates for particular types of email marketing campaigns.

### BACKGROUND OF THE INVENTION

Targeting customers with email marketing is like going on a date. The electronic commerce (e-commerce) company makes the customer comfortable by providing relevant information in a personal message, and the customer tries to understand what the e-commerce company is all about. If the customer likes the e-commerce company there is a second date, and then eventually marriage.

Accordingly, the ability to market a product or service to individuals who are accessible on the Internet is becoming increasingly important. Email systems exist today for sending email to a target set of email addresses for purposes such as marketing, information acquisition, and otherwise. A system for sending email to a number of email targets for such purposes is called an email campaign or email marketing system. Together, an internet-based email marketing system provides marketers with a fast and inexpensive way to send a personal message to potential customers.

The key to a successful email campaign is relevance by personalizing the message. It's finding the people (“targets”) who have shown interest in the product offering or who may be most likely to be interested. To facilitate relevance, marketers assemble a list of subscribers; people who have “opted in” (signed up or registered) to receive email from the marketer. The marketer gathers as much data on the subscribers as it possibly can in order to understand them better and to divide them into groups or segments, according to defining characteristics, like interests or behaviors. The marketer may then direct a personal marketing message to only those target subscribers who will be most interested. Relevance increases the effectiveness of the campaign and provides the highest rate of return on the marketing investment.

In addition, the Internet provides the capability to provide services to clients without requiring them to install additional software on their local computers. Specifically, by exploiting the client's web browser, all functional logic and all data can reside at a remote server rather than at the client's local computer (i.e., the client). As such, the client, via instructions submitted through web pages that are displayed in the web browser, can remotely invoke the functional logic to view, create, update, delete, utilize or otherwise modify the data residing on the remote server.

Many email marketing clients of email service providers or email marketing service providers struggle with moving their marketing programs beyond the rudimentary “spray and pray” tactic associated with basic email marketing campaigns. The reasons for this struggle include:
Insufficient experience with best practice strategies for more effective targeted messaging.
Email marketing platforms that lack the requisite capabilities for targeted messaging, and even when it does, it takes too many steps and is cumbersome for the time-pressed email marketer.
A high learning curve to configure the email marketing platform for targeted messaging.

Certain email service providers feature platforms with a Visio-eque interface that marketers can drag and drop flowchart components onto a pallet to construct multi-message email campaigns. The problem remains, however, that it assumes that (a) the email marketer knows what type of campaign to construct, and (b) the email marketer knows how to use these WYSIWYG tools to construct the campaigns. And even if marketers knows what email strategies to employ, they don't always have the luxury of time to spend configuring their email campaign management platforms to execute those strategies.

Another issue arises for email marketing clients due to incomplete knowledge transfer caused by organizational changes within the clients' marketing departments. A well-seasoned email marketer can easily be promoted or leave the company. All the sophisticated email programs may remain in place within the Email Service Provider's platform, but the knowledge of what they do and how to maintain them may not necessarily be passed on to the successor.

Throughout the development of email programs, it's important to move customers through the customer lifecycle—from Acquisition to brand Advocacy. An advocate of your brand is the powerful result of an effective multi-channel marketing strategy. Successful email marketing is about engaging with the customer and driving them to higher lifetime value through increased relevancy. Research indicates that a majority of email programs are not yet sophisticated, and major brands still fail to measure the long-term benefits of their email programs. That's where Strategy templates come in.

Strategy templates are designed to help marketers implement successful, advanced programs while reducing time and resources. Each template is designed to be easily implemented and automated. With a few clicks and some added creative, its possible to quickly build the advanced programs that email marketers need most.

Accordingly, there is a need for more efficient and flexible email strategy templates for email marketers. There is a need for blending these email strategy templates together with targeted segmentation of email lists to send the appropriate emails to the appropriate targets at the appropriate time. The present invention provides a solution to these needs and other problems, and offers other advantages over the prior art.

### BRIEF SUMMARY OF THE INVENTION

The present invention is related to a software system that solves the above-mentioned problems.

A computerized email message system with email strategy template for use on a network including a server with a processor and a memory is disclosed. The email message system includes a database stored in a non-transitory computer-readable media within the server memory having subscriber profile data. Each subscriber record includes an email address, a subscriber demographic, and status information for that subscriber's actions with prior emails or other events. The database further has stored therein an email strategy template for an email marketing campaign. The email strategy template has several components such as a predefined segment of the subscriber profile data that defines an initial audience for the email marketing campaign. In addition, the email strategy template includes a first and second email template with each having a default title and default content. The email strategy template also includes an email sending rule that sets a delay between sending emails based on the first and the second email templates. The email message system also includes a software module containing program code which when executed by the processor in the server causes the server to perform operations of utilizing marketer user input, the subscriber profile data in the database, and the email strategy template to create a rule for sending messages to selected subscribers with particular status information for that subscriber's actions with prior emails within the subscriber profile data stored in the database. The email message system further includes an email campaign manager containing program code which when executed by the processor in the server causes the server to perform operations of sending a personalized message to at least one selected subscriber over the network based on the marketer user created rule. As a result, the selected subscriber receives the sent personalized message as a result of having particular status information for that subscriber's actions with prior emails.

In a preferred embodiment, email marketing strategy templates give email marketing clients an understanding of the different customer persona, how different email strategies target different personas based on lifetime value and relevancy of the program, and control over what messages are sent and when they are sent within an overall email marketing campaign that is based on the template. For example, one email marketing strategy template could be a “Winback Program”. The purpose of a Winback Program is to win back or re-engage with inactive subscribers or customers of an email marketing client. Another email marketing strategy template could be a “Welcome Program”. The purpose of a Welcome Program is simply to establish an initial level of brand engagement with the new subscriber or customer of an email marketing client. Other email marketing strategy templates could include: Progressive Profiling, Engagement, Video, Social Email, Transactional, Triggered/NLP, OptDown, and Abandon Cart.

It will be appreciated by those skilled in email marketing systems that an entire library of pre-built email strategies may be created—each with a specific objective and targeted to a specific subscriber persona. The fundamental architecture of this email strategy template feature requires that new email strategies may be quickly added to the email marketing system/platform. Furthermore, these email strategy templates may include a drag-and-drop interface for creating and editing such templates by the service provider or even the email marketing clients themselves.

Additional advantages and features of the invention will be set forth in part in the description which follows, and in part, will become apparent to those skilled in the art upon examination of the following or may be learned by practice of the invention.

### BRIEF DESCRIPTION OF THE DRAWINGS

FIG. 1 shows an overview diagram for an email marketing system with email strategy templates for working with email marketing clients to send emails to subscribers or customers.

FIG. 2 illustrates components of an exemplary computing device suitable for providing email marketing strategy template programs.

FIG. 3 is a flow chart of user-input steps in creating a marketing program with the described system and method.

FIG. 4 is a screen shot of an exemplary landing page with menu bar for an email strategy template user interface.

FIG. 5 is a screen shot of a landing page of an exemplary individual program template.

FIG. 6 is screen shot of an exemplary program structure/settings page.

FIG. 7 is a screen shot of a modal for choosing recipients of the email message.

FIG. 8 is a screen shot of a message creation form in an email marketing strategy program.

FIG. 9 is a screen shot of a form to manage and track links and add custom information to a message in an email marketing strategy program.

FIG. 10 is a screen shot of a modal to edit/preview a message created in an email marketing strategy program.

FIG. 11 is a screen shot illustrating performance metrics provided once an email marketing campaign has been launched using a template.

FIG. 12 is screen shot of an exemplary program structure/settings page for a Welcome program.

FIG. 13 is a screen shot illustrating performance metrics provided once a campaign has been launched using a Welcome program template

FIG. 14 is screen shot of an exemplary program structure/settings page for a Social Influencer program.

FIG. 15 is a screen shot of a Choose Recipients modal for a social influencer marketing campaign.

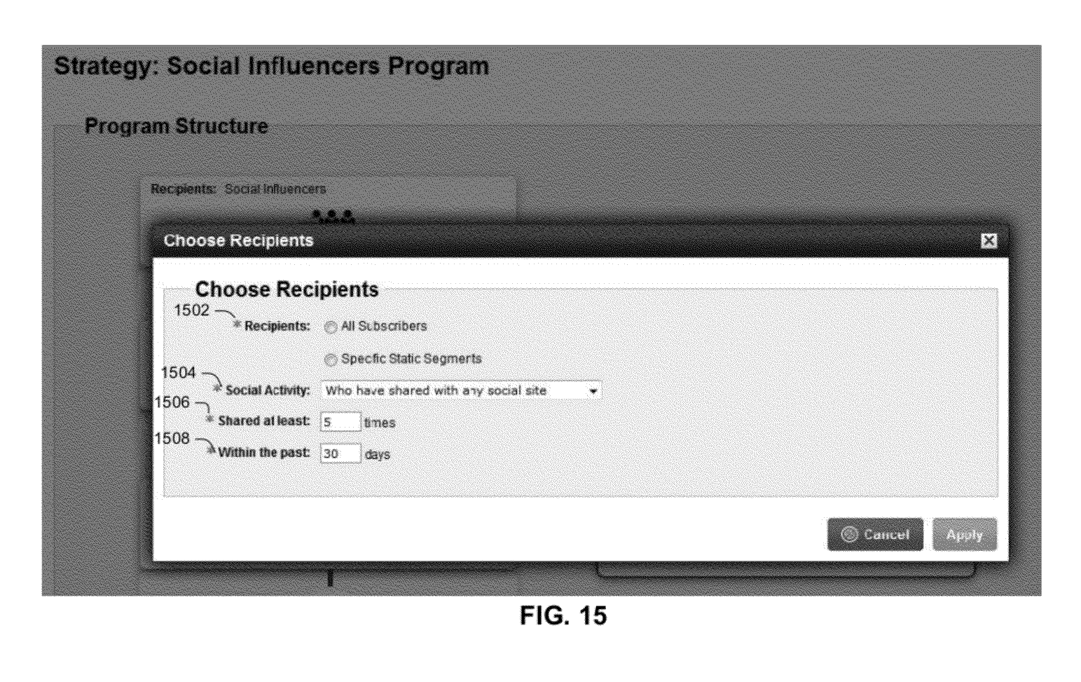

### DETAILED DESCRIPTION

The features described herein provide a system and method for managing email marketing campaigns over the internet. Using subscriber profile information, email marketing program templates with campaign-specific program structure and function data, and user input, marketing organizations are able to conduct an expert-level marketing campaign, sending personalized messages to subscribers meeting selected criteria.

In a preferred embodiment, email marketing strategy templates provide email marketing clients with an easy-to-use productized version of an email marketing strategy expert's knowledge regarding email marketing under common conditions. Email marketing strategy templates give the marketer an understanding of the different customer persona, how different email strategies target different personas based on lifetime value and relevancy of the program, and control over what messages are sent and when they are sent within an overall email marketing campaign that is based on the template. For example, one email marketing strategy template could be a “Winback Program”. The purpose of a Winback Program is to win back or re-engage with inactive subscribers or customers of an email marketing client. Another email marketing strategy template could be a “Welcome Program”. The purpose of a Welcome Program is simply to establish an initial level of brand engagement with the new subscriber or customer of an email marketing client. Still another program could be a “Social Influencers Program.” A Social Influencers Program rewards subscribers who share marketing emails with others. Additional email marketing strategy templates could include: Progressive Profiling, Engagement, Video, Social Email, Transactional, Triggered/NLP, OptDown, and Abandoned Cart. One skilled in the art would recognize that other marketing strategy templates could be implemented as well.

The definitions in Table 1 are intended to clarify terms and concepts used within this document with regard to email strategy template programs.

TABLE 1
Commonly Used Terms

| Term | Definition |
|---|---|
| ISP | Internet Service Provider at which a subscriber's email |
| | address resides. |
| Subscriber | A contact within an e-commerce system which has an email |
| | address. For purposes of this document, it may be |
| | interchanged with a customer. Subscribers opt in to receive |
| | emails and are therefore are a willing marketing contact. |
| Deliver- | A word used to describe the success of an email message's |
| ability | effectiveness. This is measured with the fields in the e- |
| | commerce system that indicate how many messages |
| | reached recipients and how many messages were bounced, |
| | received, etc. |
| Segment | A saved query generated using segmentation accessing a |
| | particular segmentation (subscriber) database used to |
| | generate a list of subscriber email addresses for an email |
| | marketing campaign |
| Marketer | A marketer is someone whose job it is to present a good or |
| | service to the market place in an attractive way so that |
| | others will be tempted to buy it. For purposes of this |
| | document, it may be interchanged with a user, client, staff, |
| | administrator, or reseller administrator. |
| Email | An electronic mail (email) message is a communication to a |
| Message | marketer's prospective customer (a subscriber) in an email |
| | marketing campaign. Messages utilizing remote |
| | segmentation may be of any type, including one-time, |
| | recurring, timed-release, etc. |

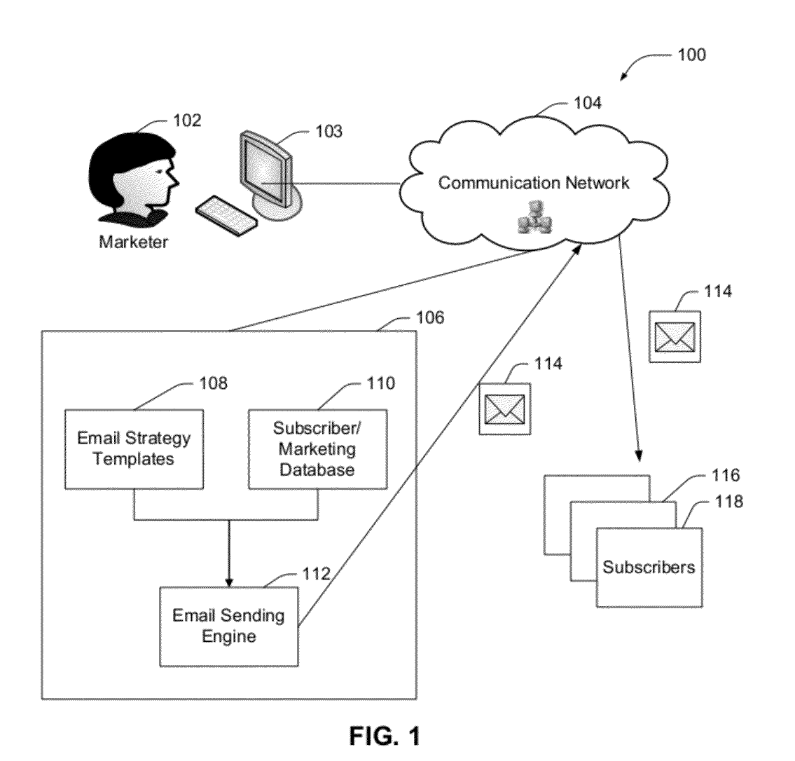

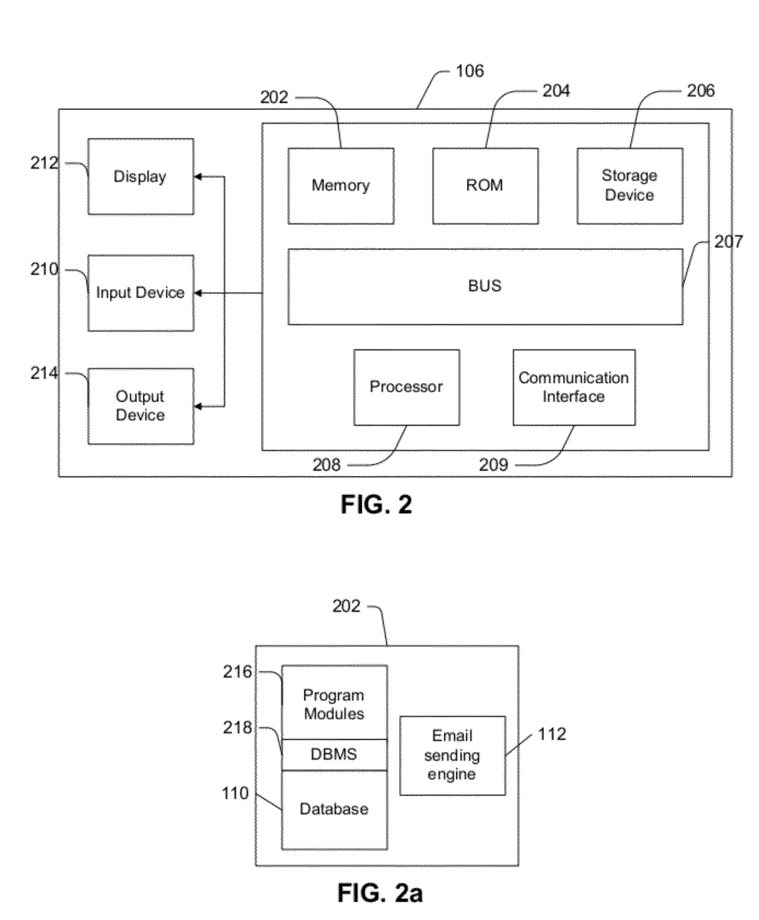

Referring to FIGS. 1 and 2, email strategy templates 108 are a component of an email marketing system 106. An email marketing system is a specialized computing machine operating on a network that allows users to create and send email messages to subscribers. Because the email marketing system provides services to others over a network, the computing machine 106 is most likely to be a specially programmed server, which allows multiple clients to access its features and capabilities. The computing machine/server 106 typically includes a memory 202, read only memory 204, a secondary storage device 206, a system BUS 207, a processor 208 (central processing unit, or CPU), a communication interface 209, an input device 210, a display device 212, and an output device 214. The memory may include random access memory (RAM) or similar types of memory.

Software applications, stored in the memory 202 or secondary storage 206 for execution by a processor 208 are operatively configured to perform the operations of the exemplary system. The software applications may correspond with a single module 216 or any number of modules. Modules 216 are program code or instructions for controlling a computer processor to perform a particular method to implement the features or operations of the system. The modules 216 may also be implemented using program products or a combination of software and specialized hardware components. In addition, the modules 216 may be executed on multiple processors for processing a large number of transactions, if necessary or desired. Other data structures and tools may also be stored in memory, such as a database 110 to store and organize information, and a database management system 218 to modify, extract and search for information within the database. The program modules 216 may access the database via queries in order to obtain operating information stored therein, such as the variables stored or configured for running email strategy template programs 108 or for creating program reports for user 102 viewing.

The secondary storage device 206 may include a hard disk drive, floppy disk drive, CD-ROM drive, DVD-ROM drive, or other types of non-volatile data storage, and may correspond with the various equipment and modules 216 shown in the figures. The processor may execute the software applications or programs either stored in memory 204 or secondary storage 206 or received from the Internet 104 or other network.

Client computers 103 access the email marketing system server 106 over a communications network, such as the internet 104. Client computers 103 may include any kind of computing device, such as a personal computer, iPad, cell phone, personal digital assistant (PDA) or any other device with internet capability, but is most often a personal computer or workstation with a memory 202, a secondary storage device 206, a processor (central processing unit, or CPU) 208, a communication interface 209, an input device 210, a display device 212, and an output device 214. The input device 210 may include any device for entering information into computer, such as a keyboard, joy-stick, cursor-control device, or touch-screen. The display device 212 may include any type of device for presenting visual information such as, for example, a computer monitor or flat-screen display. The output device 214 may include any type of device for presenting a hard copy of information, such as a printer, disk drives and other types of output devices include speakers or any device for providing information in audio form.

Although the computer or computing device 103, 106, 202 has been described with various components, one skilled in the art will appreciate that such a computer or computing device can contain additional or different components and configurations. In addition, although aspects of an implementation consistent with the present invention are described as being stored in memory 204, 206, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. One skilled in the art would recognize that computing devices may be client or server computers. Client computers and devices 103 are those used by end users to access information from a server over a network, such as the Internet 104. Servers, such as the email marketing server 106, are understood to be those computing devices that provide services to other machines, and may be (but are not required to be) dedicated to hosting applications or content to be accessed by any number of client computers. Web servers, application servers and data storage servers may be hosted on the same or different machines.

Referring again to FIG. 1, an overview diagram 100 is shown for a preferred embodiment system that provides email strategy templates 108 to client marketers 102 through a user interface connected through a communication network 104 to an email marketing system 106 (e.g., a web page displayed on a web browser operating on a local computer 103 to a marketer from an email marketing system operating on a computer server). The email marketing system 106 comprises a repository of email strategy templates 108, an email marketing database 110, and an email sending engine 112 which when activated by the marketer selects a segmented group of subscribers or customers 116, 118 to send a series of emails 114. The content and timing of the emails 114 form an email marketing campaign that are based on the email strategy templates which can be customized or personalized by the marketer 102 through the user interface to the email marketing system 106. As shown in FIG. 1, an email sending engine 112 links to a communication network 108. The email client 102 is an application used to send, receive, store and view e-mail. The communication network 104 passes emails 114 to email servers for subscribers 116, 118. It will be appreciated by those skilled in the art that an email server is a computer program or software agent operating within a computer system that transfers electronic mail messages from one computer to another typically over a communication network like the Internet.

The email marketing system database 110 contains information on subscribers and information on marketing campaigns. Information on subscribers includes at least an email address, subscriber demographic information, subscriber preferences and subscriber email and internet behaviors (e.g., actions with emails such as read/deleted/forwarded, social networking activity, abandoned ecommerce shopping carts, or other tracked user activities on websites). Also included in the email marketing system database are email strategy templates and program configuration attributes and values for email marketing campaigns. The template information includes initial audience data, segmentation data, an initial email or number of emails and follow-up email templates with titles and content and an email sending rule that sets a delay between sending emails based on the email templates.

An email marketing system 106 utilizes marketing user input, and subscriber profile data and email strategy templates from the database 110 to create rules for sending messages to selected subscribers with particular status information for the subscriber's actions with subscriber email and internet behaviors within the subscriber's profile. It will be understood by those skilled in the art that the subscriber profile data and the email strategy template data may be stored in the same or separate data structures, but are referred to in this document as “the database” for simplicity.

The email marketing system campaign manager 106 email sending engine 112 sends the message to the subscribers through the use of segmentation queries created and stored in the database 110. The queries may be based on email message characteristics, or subscriber profile information including actions performed by the subscriber with prior emails, and other events.

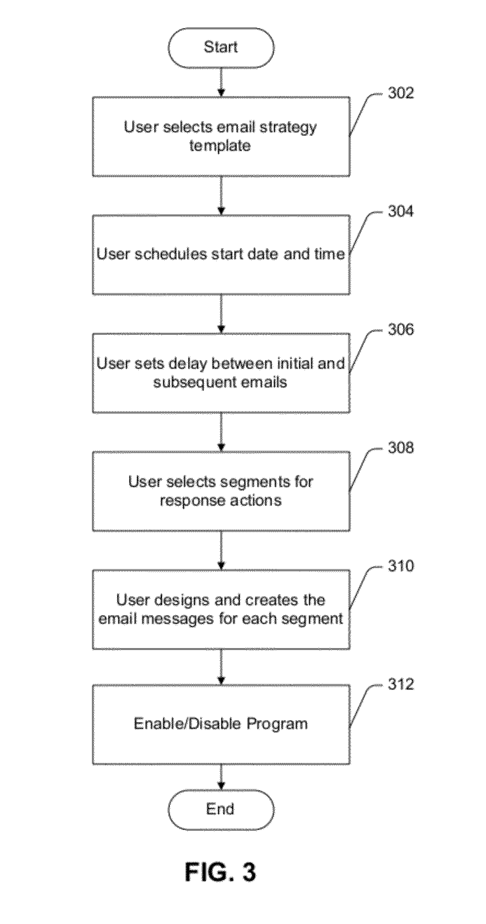

Because templates are constructed with the knowledge of an expert email marketer and are meant to offer a simple solution for those who are unfamiliar with the various marketing techniques, the email template strategy programs require minimal user input. FIG. 3 illustrates the steps performed by the marketer in setting up the program. The marketer/user chooses an email strategy template 302. The user schedules the start date and time 304 and sets the delay between initial and subsequent emails 306. The user selects segments to fill for subsequent subscriber responses or actions, if required 308, then designs and creates the email messages for each segment 310. The user then enables the program 312. The initial audience, the number and type of emails to be sent and the buckets to which initial responses (e.g. respond/non-respond) will automatically be dropped are predetermined or configurable with predetermined values, if the program requires it.

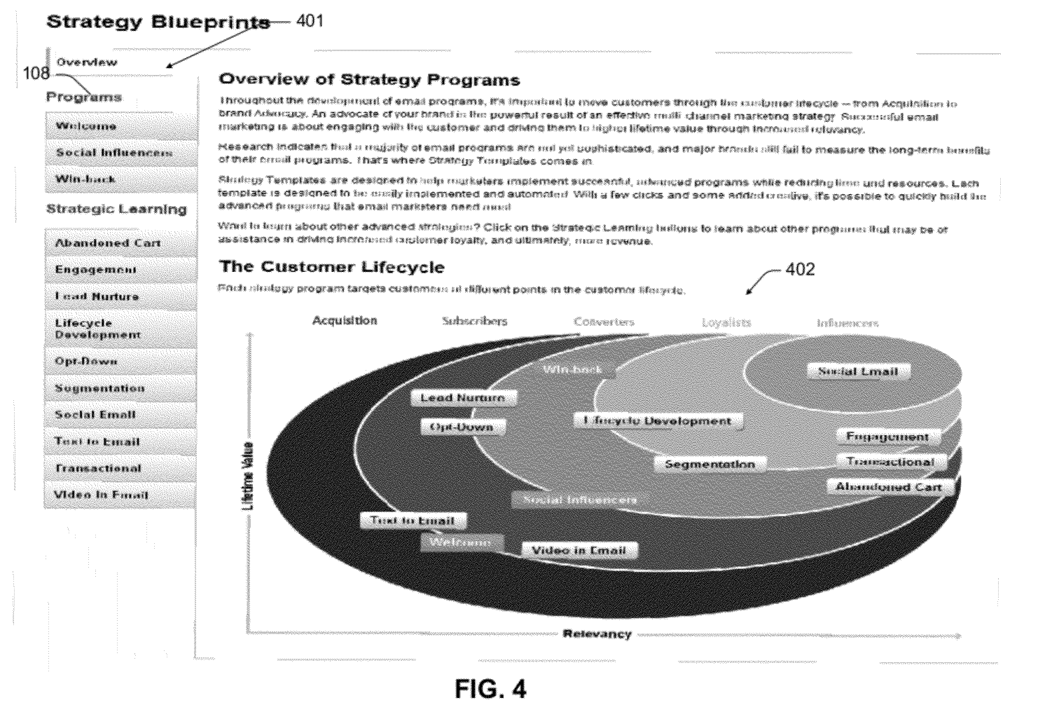

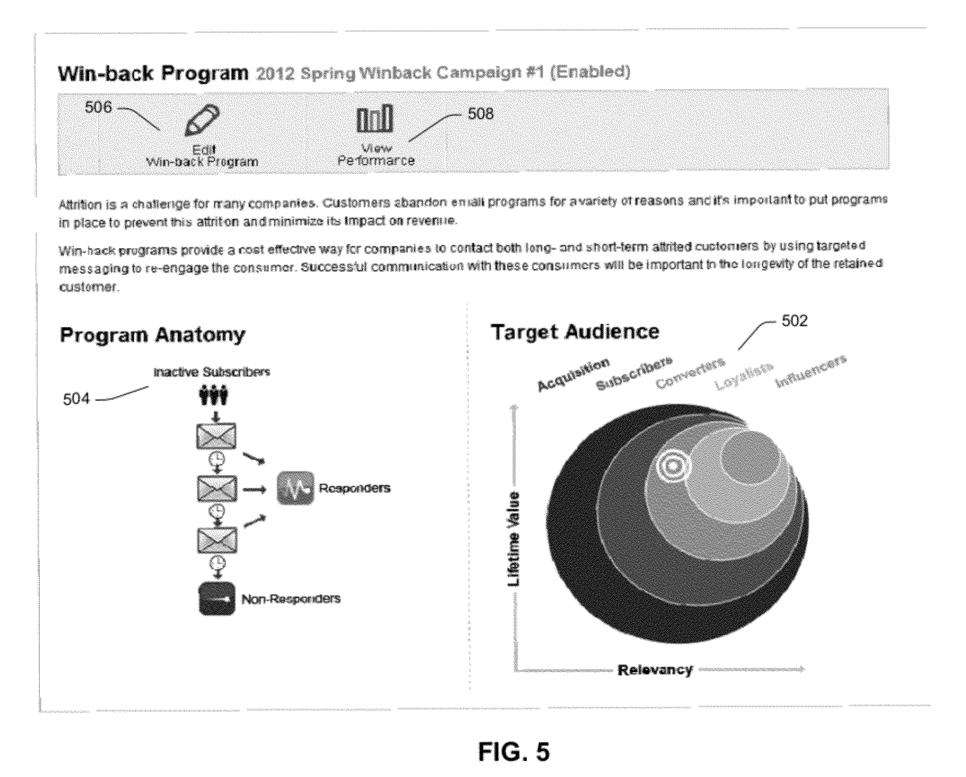

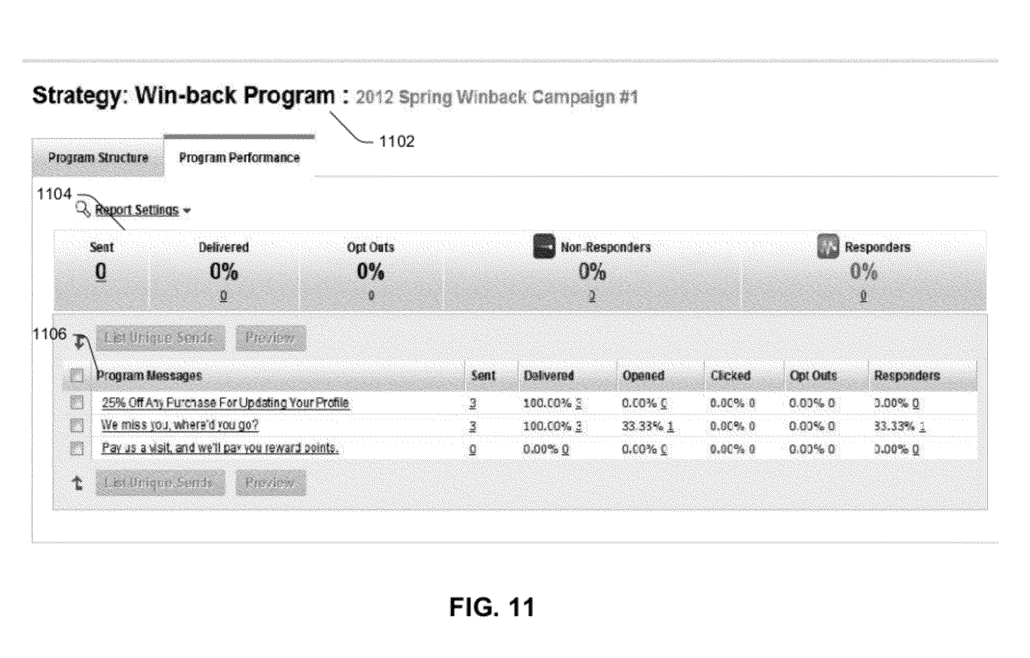

In the illustrated embodiment of FIG. 4, the Strategy tab of an email marketing system provides a gateway to using strategy template programs. Template programs 108 (in this example, Welcome, Social Influencer and Win-Back are offered as template programs) and paid services may be chosen from the menu bar on the left side of the interface 401. A landing page may be offered that preferably provides a graphical representation 402 of a customer lifecycle with descriptions so the marketer can easily choose the programs it needs for any particular campaign. The illustrated graphic 402 of one embodiment provides the marketer with a graphic of Lifetime Value v. Relevancy, with marketing programs displayed according to customer-life cycle stage (e.g. acquisition, subscribers, purchasers, loyalists and influencers). This allows users to view a description of each strategic program as well as being able to setup their strategic program via some sort of graphical interaction. The objective is to give email marketing clients (users) an email strategy template and control over what messages are sent and when they are sent within an overall email marketing campaign that is based on the template by using the illustrated graphic 402 as a navigation guide. For example, one email marketing strategy template could be a “Winback Program” described in more detail below in reference to FIGS. 5-10. The purpose of a Winback Program is to win back or re-engage with inactive subscribers or customers of an email marketing client. Another email marketing strategy template could be a “Welcome Program” (see text below in reference to FIGS. 11-13). The purpose of a Welcome Program is simply to establish an initial level of brand engagement with the new subscriber or customer of an email marketing client. Other email marketing strategy templates could include: Progressive Profiling, Engagement, Video, Social Email, Transactional, Triggered/NLP, OptDown, and Abandon Cart.

FIG. 5 illustrates the landing page when a program has been selected, in this case, a Win-back program is selected for a campaign to re-engage past customers with the client. General Information regarding the program itself, the target audience 502 and program anatomy 504, may be presented to the user. A toolbar allows the user to access the wizard to customize the program 506, and to view the performance of the marketing campaign, once the program has been enabled 508

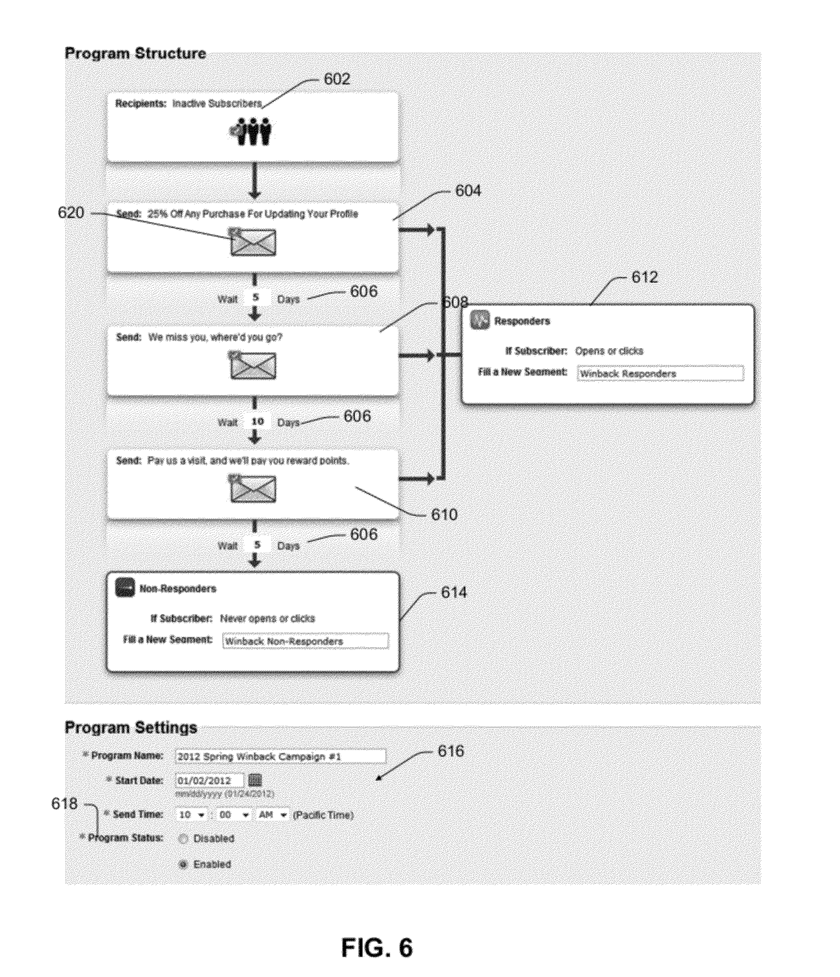

In a preferred embodiment of the email marketing system 106, the strategy template functionality begins with a wizard component providing a visual graphic to display the program's initial audience (recipients), as is illustrated in FIG. 6. The initial audience 602 from the subscriber database can be pre-defined and default for each specific strategy template program to ease the use of the strategy templates by marketing clients. This is accomplished by defining a Dynamic Segment. Dynamic Segments allow marketers to define business rules that dictate how a population of subscribers can be automatically segmented. A Dynamic Segment can be thought of as a saved search query. As a subscriber meets the criteria of that query, they are added to the segment. When they no longer meet the criteria, they are removed. Subscribers are added or removed based on unique information tied to their profile. Therefore, messaging tied to these dynamic lists is more relevant, speaking to subscribers on a more individualized level. Any segmentation data that can be searched on in an email marketing system database—domains, recency/frequency data, group associations, custom field data, etc.—can be saved in a Dynamic Segment.

The Program structure screen in FIG. 6 also shows the user how the program will be run. For example, the illustrated Program structure will send out an original email to an initial audience of subscribers 602. An initial email will be sent with an offer for performing an action such as for updating a profile 604. Two more emails will be sent out over a specified period of time 606, after delays which are configurable by the user. Buckets are created for segmented responses 608, 610. This is discussed in more detail below in the context of a Win-Back program.

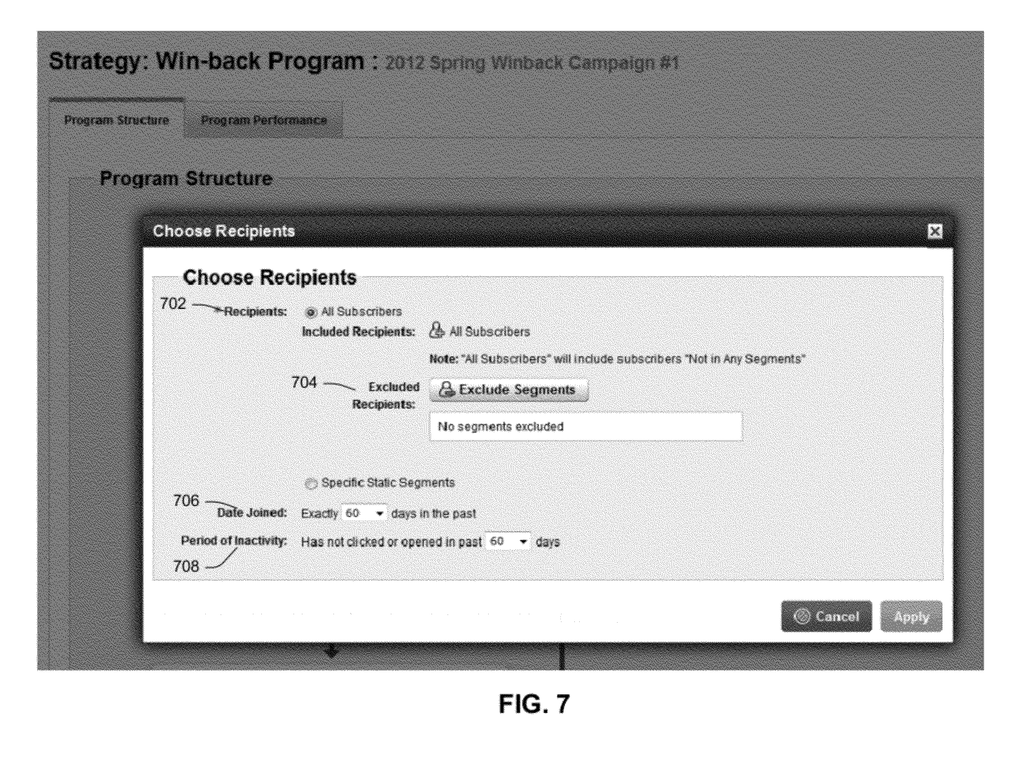

Enhanced functionality for configuring the initial audience may include hovering over the icon 602 and providing the ability to click “Choose Recipients” to open a Recipients modal window. FIG. 7 illustrates an exemplary modal for the Win-back program. The Recipients modal may differ for each strategic template program; some may be subscriber based, some may be message based. Pre-defined filters may be applied and some additional items can be made editable. By Default the status is “Incomplete”. This means that in addition to having the pre-defined audience specified by each strategy program, the user may complete the segmentation (query definition) before status is “Complete” for that part of the strategy program. The hover state in the user interface should show the current status and configuration of the recipients. In the example shown, the user may choose the subscribers to be included 702 or excluded 704 in the initial audience. They may choose the date that the subscriber joined 706 and a period of inactivity 708.

The Choose Recipients modal users can Choose Recipients at any time even while the program is running, but changes will only take effect if “Save Program” is clicked. A success message needs to be displayed on the template page when user completes editing their recipients. An example message is “Your recipients have been configured.” The initial audience Dynamic Segment and the Dynamic Segment created for each individual email will be visible on the Manage Dynamic Segment pages.

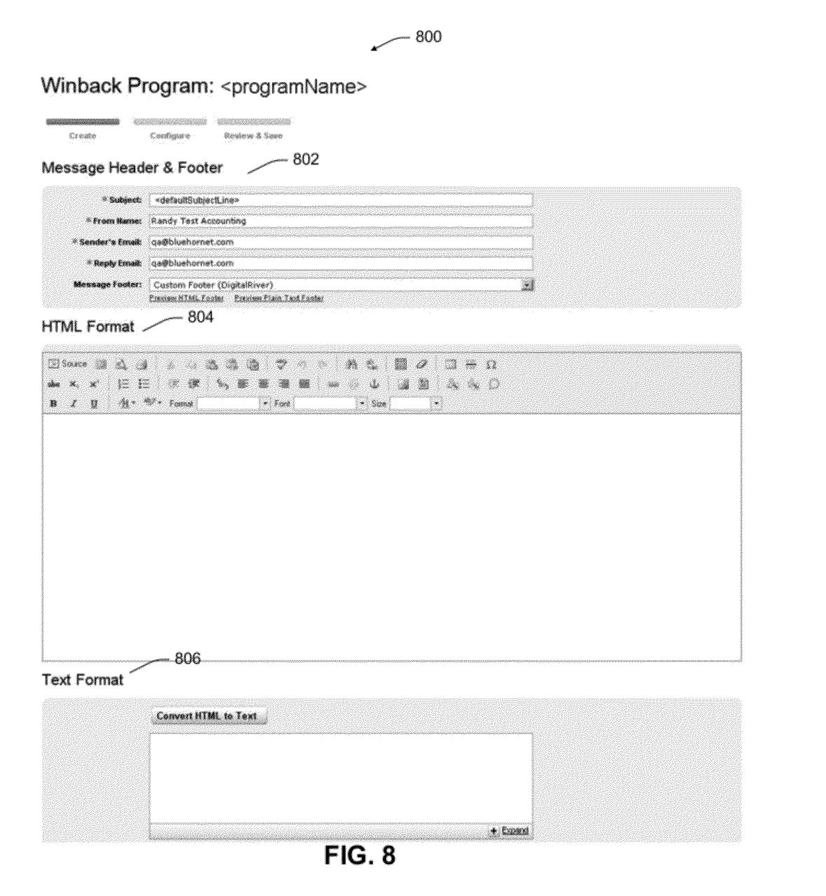

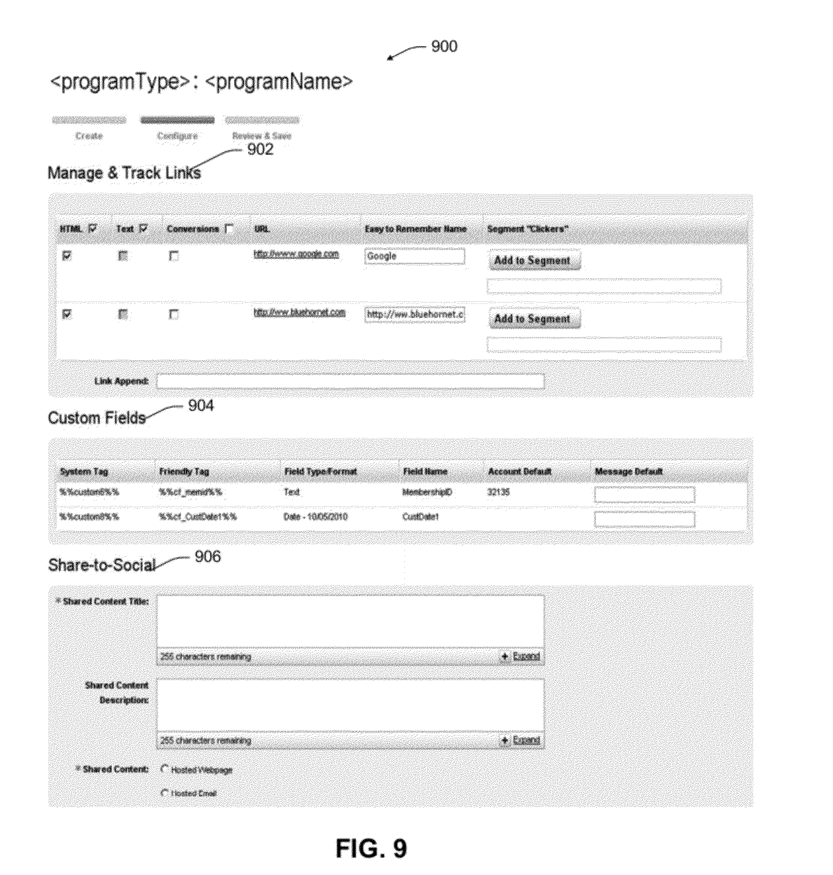

Another component of the strategy template wizard functionality is to provide a visual graphic to display and configure the program's email messages, as is shown in FIG. 8. Here, the user may create and edit, track and schedule, and review the message. A create message icon can be activated to open a Create Message dialogue box 802. Here, the user may create the message header/footer 802, details and content for both HTML 804 and Text messages 806. Content may be created on this page, or imported from a defined universal resource locator (URL). The next screen (FIG. 9) shows the track/configure page 900 which allows the user to manage and track links 902, add custom fields 904 and share content 906. A Review page allows the user to review and save the message and configuration. By default, all email messages will have Status=“Content is incomplete.” When a user clicks “Save Message” on a Review page, then Status=“Content is complete.” If a user Edits an email that has already been completed, changes will only be saved when “Save Message” on Review page is clicked, and the Status will still be “Content is complete.” If a user Edits an email that has already been completed, changes will not be saved when “Cancel” is clicked, and the Status will still be “Content is complete.”

The user defines whether the message will be a recurring message, and start date and send time may be defined on a Program Details section. Recurring messages send relevant content to subscribers as their preferences change over time, by running a saved segmentation query that selects subscribers at the time the email is sent. Additional user interface elements for Managing Recurring Messages associated to a Strategy Program outside of the Strategy Tab include review of a message, listing unique sends, delete and preview.

A basic part of the strategy template functionality is to set defaults for each parameter in an email campaign, but allow the user to modify the defaults to other predefined values. For example, the display titles for each strategic template program email are the Default Subject Line for that email. If the Subject Line is changed then the change needs to be reflected on the graphic for the display title. Each strategic program has a pre-defined Subject Line for each email and pre-defined delays between mailings. The actual delay between the mailings will be handled in the segmentation for each email. The user will need to be able to click the “Message Delay” text to change the value, which changes the value in the segmentation query in the database. For example, an Email #2 segmentation is “Sent Email #1 exactly 10 days ago and did not click or open”. If Delay between Mailing is changed to 20, then Email #2 segmentation is updated to “Sent Email #1 exactly 20 days ago and did not click or open”. A new value should be reflected on the graphic in its respective area within the user interface.

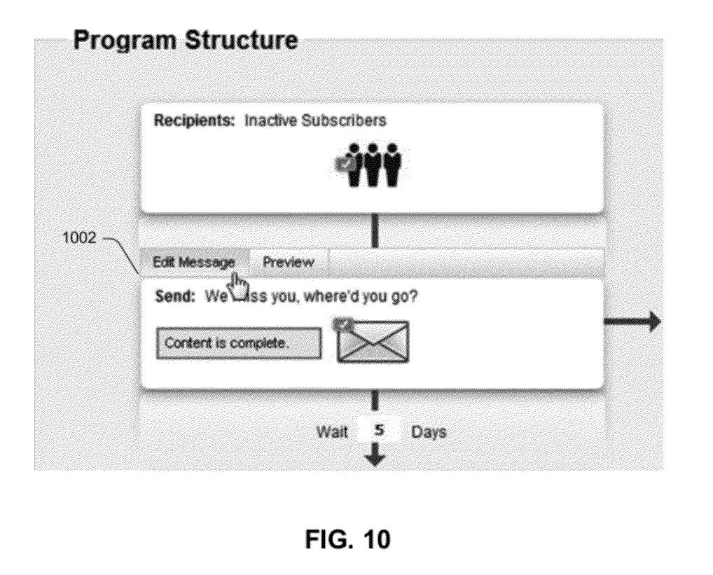

For editing the emails, when the cursor hovers over the email icon, the Edit Message and Preview bar will appear 1002 as is illustrated in FIG. 10. The user will be able to Edit Message even when the program is running and will be presented with a confirmation modal when clicking “Edit Message”. This confirmation message could state “Making changes to your email content will be applied to your program immediately after saving. Do you wish to continue?” If the Cancel button is selected, the user interface cancels out of the modal and back to the template page. If the Apply button is selected, the user interface directs the user to the Review page. The Preview option will open a modal with the Preview of the HTML/PT content.

For the Create/Edit step many of the typical options are defaulted or disabled so that the user is able to quickly move through the create process without making selections that are not appropriate for the particular email strategy program. For example, header and footer may have a default setting and the message content may be preset as well.

Similarly the Track and Schedule functionality may be set to defaults as further explained before to setting appropriate for that type of email strategy template. This means a “Winback” program may have a different email schedule setting from a “Welcome” program. Since the goal is to make these strategy programs easy to use, each program may have a preset email schedule for the emails within the respective program that forms the email campaign. Optionally, the marketer user may be given an opportunity to change these default schedules and tracking metrics to form a custom email campaign.

The user interface to these email strategy templates and the email campaigns that are executed based on the templates preferably consists of simple to use dashboards for users to start and end the program. Each email strategy is “self-aware” as to its state of completion in its own multi-step configuration process. The visual presentation of the templates displays indicators whether the configuration is either in process or completed. The dashboard may also include a Program Details section with “Program Structure” displayed. In this section, the Program Name field is enabled as a Free form text box that can be changed at anytime and may be applied when user clicks “Save Program”. Any changes will be reflected wherever the Program Name is referenced. The dashboard section will also have a Start Date and Send Time. The Save Program button in the user interface performs differently for different situations. If the Program Status is Disabled, then the save current configuration occurs but the program is not started and a message is displayed about a successful save such as “Your program has been saved.” If Program Status is Enabled, then the “Save Program” button changes to “Launch Program” (the verbiage change will only apply when coming from a saved “Disabled” state). At this point, validations must be done to confirm that the initial audience is complete, all emails have completed, all inputs for message delays are entered, Segment names for both Exit paths are entered (if applicable), Program Name, Start Date, and Send Time is entered. Subsequently, a Launch Confirmation Modal dialog box occurs. This Modal, for example, states “Your program will start on <mm/dd/yyyy at <hh:mm AM/PM. Are you sure you want to continue?”. Upon selecting the Apply button, the program is started on the Start Date and Send Time specified. After the program is Launched, the user is directed to the Strategy Landing Page and presented with a successful launch message. Whenever the Marketer stops and re-starts the program, the program will continue where the subscriber left off (If a subscriber's last email was Email #2, then when the program is restarted they should receive Email #3).

Referring back to FIG. 5, a Program Performance tab 506 may be included on the landing page to display statistics specific to each program as in FIG. 11. The Program Performance tab may be displayed only after the program is up and running. Each strategic program may display a different set of metrics. These metrics may include a direct link to a list of that email's unique sends (the “List Unique Sends” list page for a selected Recurring Message).
Email Strategy Template—Winback Program

For the above described email marketing system and functionality a better understanding may be gained by reviewing a specific example of using an email strategy template. It will be appreciated by those skilled in the art that the following description is illustrative only and by no means is meant to limit the scope of the types of or features of email strategy templates that could be implemented without departing from the scope and spirit of the present invention and claimed below. In this example, a WinBack program is described with reference to FIG. 3, which illustrates the process flow for using an email strategy template, and FIGS. 5 through 10 which show a graphical user workflow that helps guide the user visually and functionally. This workflow will provide the following capabilities:
Identify the initial audience from the subscriber list for the Winback program (Subscribers who have not interacted with an email for a certain period of time) and to have subsequent emails auto-segment based off of the initial audience and their interaction with an email 602, 702
Select when the Winback program is to start via a scheduling tool (program settings) 616
Select the delay between each email message of the messaging stream (ie. wait 5 days after the first email to send the second email) 606
Provide the name of the segment that holds the Winback Program Responders, those that interacted with an email in the program will automatically get added 612
Provide the name of the segment that holds the Winback Program Non-responders, those that never interacted with any email in the program will automatically get added 614
Provide access to configure the emails for each of the three messages in the stream 620, 802
Enable/Disable the Winback program (which in turn enables/disables each of the emails of the program) 618

The Customer WinBack strategy template programs are initially looking for subscribers who have no activity for the previous 60 days 704. The program will send out three staggered emails: “discount to update profile 604,” “we miss you 608” and “pay us a visit and earn rewards 610.” First, the system sends the “discount to update profile 604” email. If the subscriber opens or clicks this email, the subscriber will become a member of the “recaptured” stream 612, by identifying and storing this user action in the database. If the subscriber has not opened or clicked the first email after 5 days, the system will send out the “we miss you 608” email. If the customer opens or clicks this email, the subscriber becomes a member of the recaptured stream. If not, the system will wait 10 days and send out another email with “pay us a visit and earn rewards 610.” If the subscriber opens or clicks this email, the subscriber will become a member of the recaptured stream; if not, the customer becomes a member of the “inactive” segment 614.

The initial audience 602 for the “Winback Program Candidates” may be pre-defined according to known marketing concepts, with some options for user selection. The user may choose to include 702 or exclude 704 certain segments. A default dynamic segment of Winback program candidates of subscribers in the database may be that the subscribers have joined the marketing database exactly 60 or 180 days previously and have been sent at least one email within the past 90 days. Further, the subscriber has neither Clicked nor Opened that email. The “Date Joined” 706 option can be configured as a drop down list for the number of days (e.g. 60, 90, 120, 150, 180, 270 or 360 days), selectable by the marketer. The “Period of Inactivity” 708 can also be selected from a drop down list for a number of days (e.g. 60, 90, 120, 150, 180, 270 or 360 days) that is selectable by the marketer. By default the Recipient Icon will have a status of “Incomplete”. When the cursor hovers over the icon, the following items will pop-up: in the user interface: Edit Recipients, Status, and Recipient Summary box. In editing recipients the user interface shows the recipients modal dialog box where they are required to make the initial selection of “All Subscribers” or “Specific Segments” in addition to the pre-defined audience filter. After recipients are configured and “Save” is clicked, the user interface returns back to the Winback Strategy Template. For a hover action, the recipient icon should have a “Completed” status with the recipients summary box populated.

The marketer can create content, send a basic test modal, track links, review and send messages and confirm editing. Referring to FIG. 6, the marketer can click on the icon 620 for each of the three emails of the Winback program that opens a pop-up screen where he can provide (FIG. 8) or edit 1002 the details of each message. Preferably, the Winback program emails are treated as Recurring Messages, but with certain modifications. A more detailed description of the recurring messages functionality is given in U.S. patent application Ser. No. 11/607,746 entitled “Recurring Message System and Method” which was filed on Nov. 30, 2006, and which is incorporated herein by reference. The Create Step is the same except that the Message Name Default is a follows:
First email: “Discount to update profile 604.”
Second email: “We miss you, where did you go? 608”
Third email: “Pay us a visit and earn rewards 610.”

All 3 emails may look and behave the same. The differences may be that the Default Subject Line and the segmentation. For Email Message #1, the Default Include Recipients is Initial Audience “Winback Program Candidates” described above. The Default Exclude Recipients are Subscribers who were Sent Email Message #1. By default the status is set to “Incomplete” and only when the user clicks “Save” on Review page will status be “Complete”. For Email Message #2, the Default Include Recipients are (Sent “Email Message #1” 5 Days in the Past) AND (did Not Open or did Not Click “Email Message #1”). This “5 Days in the Past” may be an option editable by users. The “did Not Click” query implies the “did not click ANY link” in “Email Message #1” may be selected from deliverability reports. The Default Exclude Recipients are Subscribers who were Sent Email Message #2. As with Message #1, the default status should be “Incomplete” and only when the user clicks “Save” on Review page will status be “Complete”. For Email Message #3, the Default Include Recipients is (Sent “Email Message #2” 10 Days in the Past) AND (did Not Open nor Click “Email Message #2” OR “Email Message #1). The “10 Days in the Past” may be an option editable by users. The “did Not Click” query implies the “did not click ANY link” in “Email Message #2” was selected from the deliverability reports. The Default Exclude Recipients are Subscribers who were Sent Email Message #3. The default the status should be “Incomplete” and only when user clicks “Save” on Review page will status be “Complete”.

The track step operates similar to recurring messages functionality, in that the message is created from the template and is sent out to the initial audience. Frequency is preprogrammed to allow follow up emails using the same template. Once the subscriber receives the email, they won't receive another email for the same condition. For example, the Win-back program runs every day, but Win-back email follow up will be to the person who received it within a recent period of time. Recipients will be different each time.

The Schedule Step may have items automatically set by default, including:
Enable/Disable Message, driven by Enabling/Disabling of the Winback Program.
Suspend Delivery until the segments have been refreshed is set to the default option, “Disabled”.
Duration of the message, driven by the scheduling of the Winback Program.
Sending Pattern has Sending to Recur: set to “Daily” and the send time for all three message of the Winback program are set to the send time set for the Winback program.
Message Throttling send rate is set to the default option, “Maximum Messages per hour”.

The Review and Send step may allow the user to review all field sets accept those associated with the Schedule Step. The individual emails within the program will only be accessible via the Winback Program pages.

There may be a visual representation as to the status of the different elements that need to be completed before the Winback Program can be Enabled. An example user interface is shown in FIGS. 6 and 10 where the green colors indicate completion of a required item. Several items are required before Enabling the Winback program, including: Setup of initial audience, Completion of all 3 email messages, Setup of the Winback Program Responder segment, Setup of the Winback Program Non-responder segment, and Scheduling the Winback strategy program. The Winback strategy program can also be Disabled and Enabled as many times as needed.

In a preferred embodiment, once a Winback strategy program or campaign is launched, a marketer is given the option to view several performance metrics as are illustrated in FIG. 9. For example, the performance screen may provide a status bar with statistics regarding the overall campaign 902, presenting, for example, the number of emails sent, delivered, opted-out and the number of non-responders and responders. A program message section 904 provides statistics on each individual message and the actions taken by the recipient.

The report may display each recurring message of the Winback program together with the delivery and response metrics for each of the three messages of the program. More specifically, the following are shown in the sample report within FIG. 11:
Name of the email program (in this case: “Winback Program”) 1102
Overall report statistics (numbers sent, percent delivered, opt outs, non responders and responders) 1104
Message statistics (name of the program message; number sent; number delivered, clicked or opened; opt-outs, responders) 1106

To facilitate future emails or other reporting functionality, the subscriber database may have some pre-defined segments created for the Winback Strategy Program. One segment may be the “Winback Program Responders” segment. This segment has a definition of a subscriber who has responded: (Has Opened or Clicked “Email Message #1” OR “Email Message #2” or “Email Message #3”) AND (Is not in the “Non-Responder” segment). The segment needs to be a Static Segment and also include the Date Joined Segment profile data for the subscriber. This Static Segment needs to be a “Live” type Static Segment and needs to have a Category of “Uncategorized”. For the segmentation engine, an auto-fill logic may be set to run nightly at 12 am (PST). Anytime the Segment name is changed and user clicks “Save Program”, a new segment from the database is created.

Another segment may be the “Winback Program Non-Responders” segment. This segment has a definition of a subscriber who has not responded: (Sent “Email Message #3” 5 Days in the Past) AND (did Not Open nor Click ANY email in the program). The “5 Days in the Past” may be an option editable by users. The “did Not Click” query implies the “did not click ANY link” in “Email Message #3”. The segment needs to be a Static Segment and also include the Date Joined Segment profile data for the subscriber. This Static Segment needs to be a “Live” type Static Segment. This Static Segment needs to have a Category of “Uncategorized”. If a subscriber clicks or opens any of the program emails after they have been added to the non-responder segment, the subscriber will stay in that segment and not be added to the responder segment. “. For the segmentation engine, an auto-fill logic may be set to run nightly at 12 am (PST).
Email Strategy Template—Welcome Program

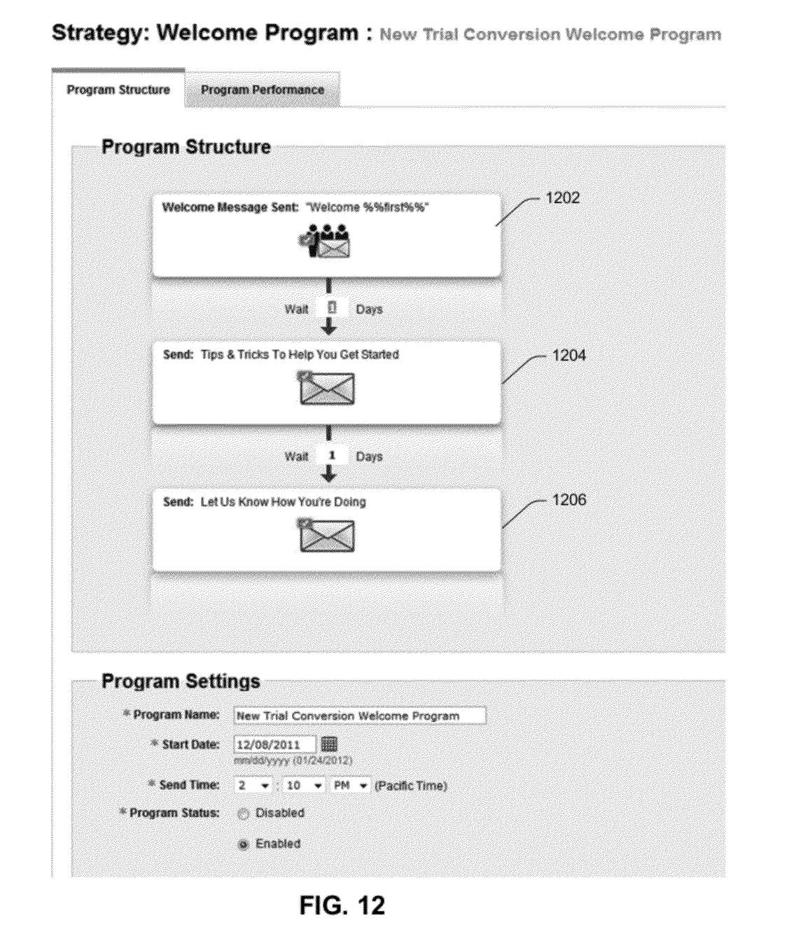

Another example of an email strategy template is a welcome program. An exemplary welcome program, program structure screen is shown in FIG. 12. A welcome email starts a relationship with a potential customer on the right track. Sometimes a series of welcome emails is needed to communicate important information to the potential customer, allowing the marketer to further position the brand, product or company. For example, a cosmetic retailer would like to share information about their products and services. Through a welcome series, they develop three emails that talk about how the products are made, the charities that benefit from certain purchases, or how the founder uses the product. A welcome series helps to begin building a relationship with the user. Messages should be short and contain useful information that benefits the user.

A Welcome Program is similar to WinBack program in that multiple messages are sent to segmented lists of subscribers from the subscriber database 1202, 1204, 1206. The Default “Welcome Program Candidates” to whom the follow up emails are sent are based on subscribers who were sent a specific Welcome Message selected by a client 1202. If the marketers account has only one enabled Welcome Message, then that Welcome Message may be preselected. If the marketers account has multiple enabled Welcome Messages, then the program may provide a Choose Welcome Message Modal and only display “Enabled” Welcome Messages. As a default this segmented group is set to Date Sent=Exactly 2 days in the past, but could be changed by the marketer selecting a value from a drop down list of values, say, between 1 and 15. The user/marketer also may Include and Exclude Static Segments to further define their initial audience.

In a preferred embodiment of this email strategy template, two follow-up email messages are available for the Welcome Program. Follow-up email message #1 1204, includes recipients set to subscribers who were sent the selected Welcome Message. A Default Exclude Recipients choice may be Subscribers who have been sent Email Message #1. The follow-up email Message #2 1206 recipients may include subscribers who were sent follow-up email message #1 exactly 2 days in the past. The Default Exclude Recipients are Subscribers who have been sent Email Message #2.

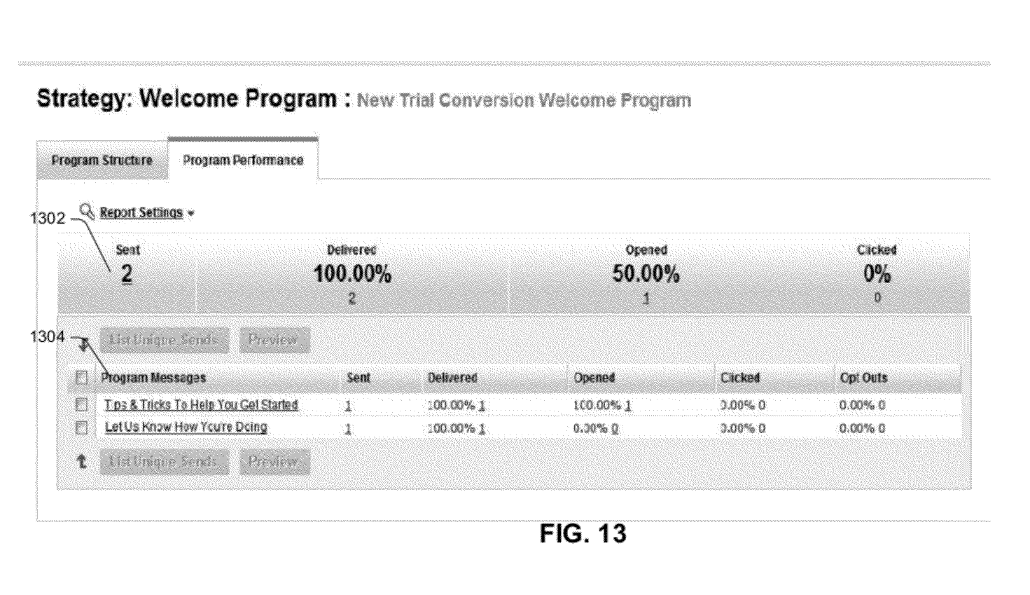

As with the Winback Program, several performance metrics (FIG. 13) are displayed to a user/marketer in running total summary for the program. The metrics include program metrics 1302 as well as program message metrics 1304. Program message metrics include number sent, delivery rate, opens rate (unique opens), clicked rate (unique click-to-open) and Opt-Out rates.
Email Strategy Template—Social Influencers Program

Customers who have become influencers within the customer lifecycle are important to long-term revenue growth. These subscribers have spread the word about the marketer's products and services, so marketers would like to keep them happy and engaged by sending rewards based on their sharing behavior.

A social influencers program may be provided to allow marketers to send targeted messages to subscribers based on their share activity. Once they reach each “level” of share actions, the system can automatically send them messages that include special coupons, private discounts, access to exclusive information, or just a simple thank you message.

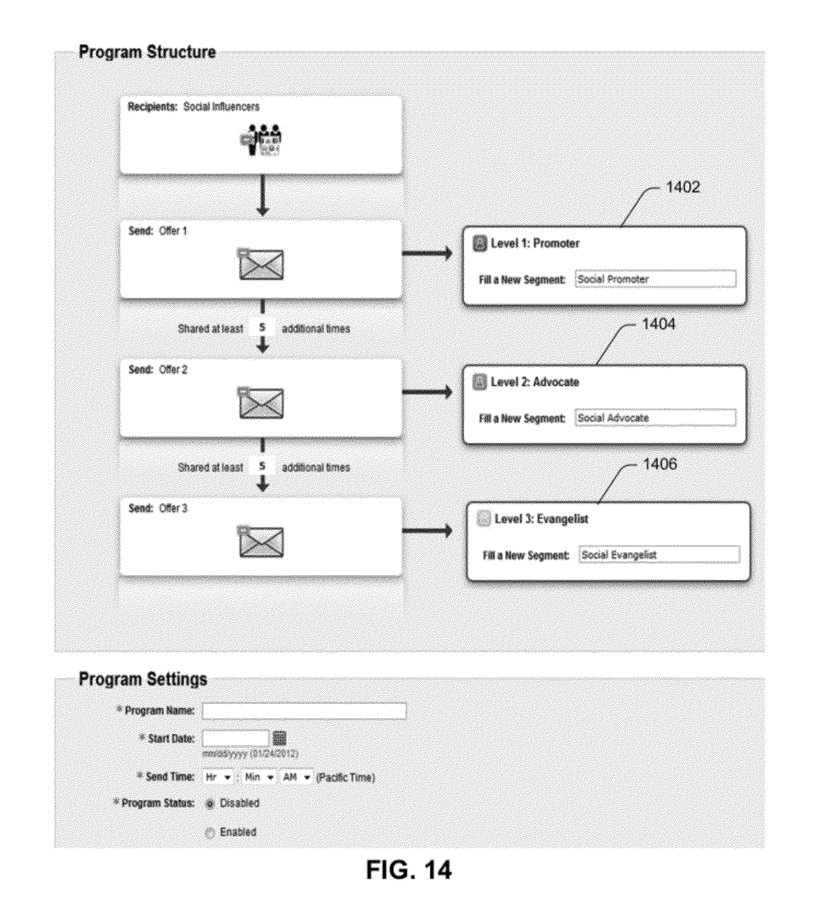

Various levels of social influencer may be identified for the program. FIG. 14 illustrates a program structure with three levels of social influencer: a social promoter 1402, a social advocate 1404, and a social evangelist 1406. Marketers may select the number of times each has shared offers with others 1406 and create content for each of them. The recipients chosen for this program may be determined by specific segments 1502; by social activity (e.g. have shared with any social site, or have shared with a specific social site) 1504; have shared at least a specific number of times 1506; and have shared within the past number of days 1508. Subscribers may be added into a segment based on which email they receive; each subscriber is in only one segment.

The program structure for a social influencer strategy is to send a particular email to each subscriber as they hit the level specified by the criteria. For example, a social promoter can become a social advocate and a social evangelist and benefit from the rewards offered in each of the levels.

Various information may be available on the dashboard to monitor program performance for a social influencers program, including a subscriber section, with the number of subscribers in each segment and the rate of the segment (i.e. the current number of subscribers in the segment/the total number of valid subscribers); a message performance section with the number of emails sent, delivered, opened and (unique) clicked for each message; and an email performance section.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the web interface such that different dialog boxes are presented to a user that are organized or designed differently while maintaining substantially the same functionality without departing from the scope and spirit of the present invention.

What we claim:

1. A computerized email message system with email strategy template for use on a network including a server with a processor and a memory, comprising:
a database stored in a non-transitory computer-readable media within the server memory having subscriber profile data where each subscriber record includes an email address, a subscriber demographic, and status information for that subscriber's subscriber email or internet behaviors, the database comprises stored therein an email strategy template for an email marketing campaign, the email strategy template comprising:
a definition of the email strategy and its objective, a depiction of the customer persona that the strategy is targeted towards and how it is applicable based on a comparative measure of customer lifetime value and relevancy of program, and a schematic overview of the email strategy showing a pre-defined sequence of email messages and exit paths of the program;
a predefined segment of the subscriber profile data that defines an initial audience for the email marketing campaign;
a first email template with a default title and default content;
a second email template with a default title and default content;
an email sending rule that sets a delay between sending emails based on the first and the second email templates;
a software module containing program code which when executed by the processor in the server causes the server to perform operations of utilizing marketer user input, the subscriber profile data in the database, and the email strategy template to create a rule for sending messages to selected subscribers with particular status information for that subscriber's email or internet behaviors within the subscriber profile data stored in the database; and
an email campaign manager containing program code which when executed by the processor in the server causes the server to perform operations of sending a personalized message to at least one selected subscriber over the network based on the marketer user created rule whereby the selected subscriber receives the sent personalized message as a result of having particular status information for that subscriber's email or internet behaviors.

2. The email message system of claim 1 wherein the rule for sending messages comprises a starting date and an ending date.

3. The email message system of claim 1 wherein the rule for sending messages comprises an enabled state.

4. The email message system of claim 1 wherein the software module comprises program code which when executed by the processor in the server causes the server to perform operations of an editor for creating dynamic content for the personalized message.

5. The email message system of claim 4 wherein the editor creates create dynamic content in a format selected from a group consisting of: plain text, rich text, and hypertext markup language.

6. The email message system of claim 1 wherein the rule for sending messages comprises setting an interval based on one of: a day of week, a time of day, and a day of month.

7. The email message system of claim 2 wherein the rule for sending messages comprises a rule based on group membership.

8. The email message system of claim 1 wherein the software module comprises program code which when executed by the processor in the server causes the server to perform operations of providing statistics to a user related to campaigns based on the email strategy template.

9. A method for managing email marketing messages for use on a network performed by a server having a processor and memory operating under the control of program code within a software module, the method comprising steps of:
storing subscriber profile data in a database stored in the server memory where each subscriber record in the database includes an email address, a customer demographic, and a subscriber's email or internet behavior;
storing a library of email strategy templates in a database stored in the server memory where each email strategy template includes initial audience data, segmentation data, an initial email and follow-up email templates with titles and content;
utilizing business user input entered through an interface to the server, the subscriber profile data and the template program data in the database to create a rule setting a delay between sending the initial email and follow-up email based on the stored email templates to selected subscribers in the database with particular stored subscriber's email or internet behavior; and
sending a personalized message to at least one selected subscriber over the network from the server based on the business user created rule whereby the subscribers are sent personalized message as a result of having a stored subscriber's email or internet.
